(19) United States
(12) Patent Application Publication
(10) Pub. No.: US 2026/0161866 A1
(43) Pub. Date: Jun. 11, 2026

(54) ENSURING ARBITRATION FAIRNESS IN A NETWORK-ON-CHIP

(71) Applicant: ARTERIS, INC., Campbell, CA (US)

(72) Inventors: Amir CHARIF, Paris (FR); Xavier VAN RUYMBEKE, Montigny-le-Bretonneux (FR); Xinyu LI, Montigny-le-Bretonneux (FR); Stéphane CIZAIRE, Chaville (FR)

(73) Assignee: ARTERIS, INC., Campbell, CA (US)

(21) Appl. No.: 19/390,673

(22) Filed: Nov. 17, 2025

Related U.S. Application Data
(60) Provisional application No. 63/721,425, filed on Nov. 15, 2024.

(51) Int. Cl. G06F 30/33; G06F 115/02

(52) U.S. Cl. CPC G06F 30/33; G06F 2115/02

(57) ABSTRACT

A computer-implemented method includes accessing a network-on-chip (NoC) design in which a plurality of switches connect initiators to targets. The plurality of switches includes at least one merger-type switch having an arbiter and a plurality of inputs. For each merger-type switch, the number of initiators on the plurality of inputs is identified. Then a baseline number of initiators per input connection is determined. For each merger-type switch, if the number of initiators on an input exceeds the baseline number of initiators, and if access times on that input are unbalanced, then that input is split into a plurality of segments so that each of the segments carries the baseline number of initiators. The method ensures arbitration fairness without changing deadlock freedom of the NoC design.

### CROSS REFERENCE TO RELATED APPLICATION

This application claims the benefit of US Provisional Application Serial No. 63/721,425 filed on November 15, 2024 and titled SYSTEM AND METHOD FOR NETWORK ON CHIP (NOC) USING AUTOMATION DESIGN TOOL by Amir Charif et al., the entire disclosure of which is incorporated herein by reference.

### FIELD

The present technology is in the field of electronic computer-aided design of electronic systems and, more specifically, related to design of a network-on-chip (NoC).

### BACKGROUND

A system on chip (SoC) may include initiators, targets, and a network-on-chip (NoC) for handling communications between the initiators and the targets. A NoC is superior to point-to-point connectivity by way of a more scalable communication architecture that makes use of packet transmissions. It can support an ever-increasing number of cores on a single chip and a demand for ever-increasing processing power related to artificial intelligence (AI) and other applications.

During design of an SoC, an SoC architect designs a specification that includes a floorplan, power strategy, and constraints related to the SoC’s environment. The floorplan defines areas on the SoC for major functional blocks, including initiators and targets, and it defines an area that will be used for a NoC. The specification also defines constraints on the NoC.

During design of a NoC, a NoC topology is generated within the area defined by the floorplan. Generating the NoC topology involves placing and legalizing standard cells, and making wire connections between the NoC elements.

A cascaded pattern of switches in a physically-aware NoC topology is common, as it favors wire sharing. However, even when there is sufficient bandwidth to allow access from all of the initiators to all of the targets, all of the initiators will not experience the same latency. Consequently, an initiator that is closest to the targets might have disproportionately greater access times than initiators that are further away. As a result, the initiators that are farther away will have less time to communicate with the targets.

### SUMMARY

In accordance with various embodiments and aspects herein, a computer-implemented method includes accessing a network-on-chip (NoC) design in which a plurality of switches and edges connect initiators to targets. The plurality of switches includes at least one merger-type switch having an arbiter and a plurality of inputs. For each merger-type switch, the number of initiators on the plurality of inputs is identified. Then a baseline number of initiators per input connection is determined. For each merger-type switch, if the number of initiators on an input exceeds the baseline number of initiators, and if access times on that input are unbalanced, then that input is split into a plurality of segments so that each of the segments carries the baseline number of initiators. The method ensures arbitration fairness without changing deadlock freedom of the NoC design.

In accordance with various embodiments and aspects herein, a design tool or an electronic aided design tool or a product includes non-transitory computer readable medium for storing a tool including code that, when executed by a processing unit, causes

the tool to access a network-on-chip (NoC) design in which a plurality of switches connect initiators to targets. The plurality of switches includes at least one merger-type switch having an arbiter and a plurality of inputs. The code, when executed, further causes the tool to identify the number of initiators on the plurality of inputs in each merger-type switch; and determine a baseline number of initiators per input connection. The code, when executed, further causes the tool to perform the following for each merger-type switch: if the number of initiators on an input exceeds the baseline number of initiators, and if access times on that input are unbalanced, that input is split into a plurality of segments so that each of the segments carries the baseline number of initiators.

In accordance with various embodiments and aspects herein, a computing system includes a processing unit; and computer-readable memory encoded with a network-on-chip (NoC) design tool. The tool includes code, that when executed, causes the processing unit to access a network-on-chip (NoC) design in which a plurality of merger-type switches connect initiators to targets. Each of the merger-type switches has an arbiter and a plurality of inputs. The code, when executed, further causes the processing unit to identify in each merger-type switch the number of initiators on the plurality of inputs; and determine a baseline number of initiators per input connection. The code, when executed, further causes the processing unit to perform the following for each merger-type switch: if the number of initiators on an input exceeds the baseline number of initiators, and if access times on that input are unbalanced, that input is split into a plurality of segments so that each of the segments carries the baseline number of initiators.

### BRIEF DESCRIPTION OF THE DRAWINGS

In order to understand the invention more fully, a reference is made to the accompanying drawings. The invention is described in accordance with the aspects and

embodiments in the following description with reference to the drawings or figures(FIG.), in which like numbers represent the same or similar elements. Understanding that these drawings are not to be considered limitations in the scope of the invention, the presently described aspects and embodiments and the presently understood best mode of the invention are described with additional detail through the use of the accompanying drawings.

FIG. 1 shows an example of an electronic system including a NoC.

FIG. 2 shows a method of generating a hardware description of a NoC in accordance with various aspects and embodiments herein.

FIG. 3 shows a connectivity table in accordance with various aspects and embodiments herein.

FIG. 4 shows an example of a portion of a NoC topology.

FIG. 5 shows a method of ensuring arbitration fairness in a NoC design in accordance with various aspects and embodiments herein.

FIG. 6 shows modifications to the NoC topology of FIG. 4 to ensure arbitration fairness in accordance with various aspects and embodiments herein.

FIGS. 7A, 7B and 7C show switch reuse in a NoC topology to ensure arbitration fairness in accordance with various aspects and embodiments herein.

FIG. 8 shows a method of ensuring arbitration fairness in a NoC design in accordance with various aspects and embodiments herein.

FIG. 9 shows a computing system including computer-readable memory that stores a NoC design tool in accordance with various aspects and embodiments herein.

### DETAILED DESCRIPTION

The following describes various examples of the present technology. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment.

Thus, appearances of the phrases “in one embodiment,” “in at least one embodiment,” “in an embodiment,” "in certain embodiments," and similar language throughout this specification may, but do not necessarily, all refer to the same embodiment or similar embodiments. Furthermore, aspects and embodiments described herein are merely exemplary, and should not be construed as limiting of the scope or spirit of the invention as appreciated by those of ordinary skill in the art. All statements herein reciting principles, aspects, and embodiments are intended to encompass both structural and functional equivalents thereof. It is intended that such equivalents include both currently known equivalents and equivalents developed in the future. Furthermore, to the extent that the terms "including", "includes”, “having", "has", "with", or variants thereof are used in either the detailed description and the claims, such terms are intended to be inclusive in a similar manner to the term "comprising."

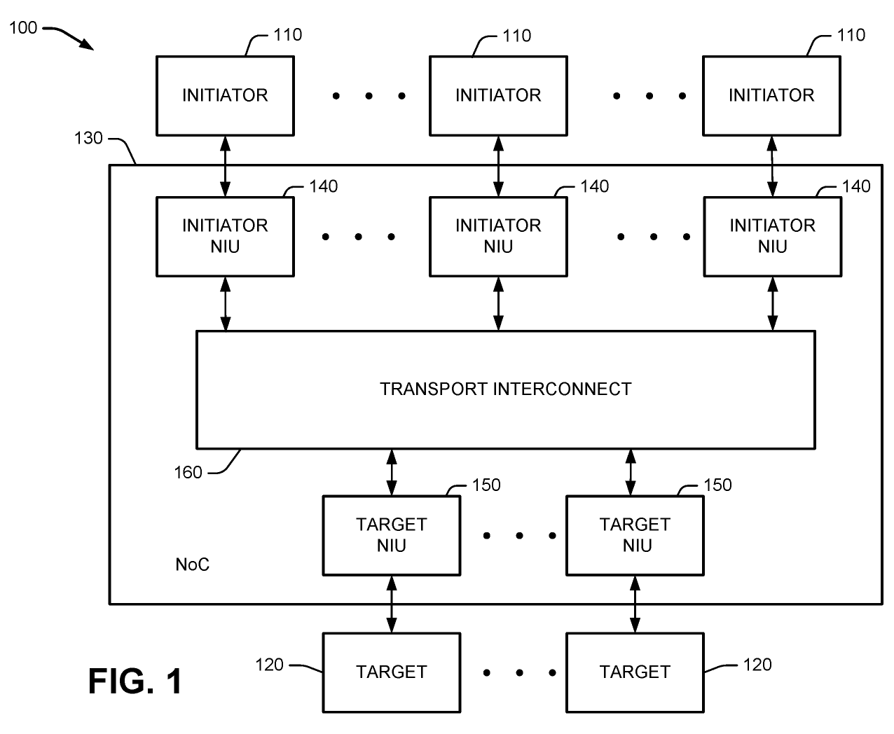

Reference is made to FIG. 1, which illustrates a simple example of an SoC 100 including a plurality of initiators 110 and targets 120. Examples of the initiators 110 include central processing units (CPUs), graphics processing units (GPUs), video cards, accelerators, and direct memory access (DMA) controllers. Examples of the targets 120 include volatile memory, persistent memory, and peripherals.

The SoC 100 further includes a NoC 130. The NoC 130 sends request transactions from an initiator 110 to one or more targets 120. For example, the NoC 130 receives a request transaction from an initiator 110, decodes an address in the request transaction, and transports the request transaction to the target 120, which handles the request transaction. The target 120 may respond with a response transaction, which is transported back to the initiator 110 via the NoC 130.

The NoC 130 includes a plurality of network interface units (NIUs) 140 and 150 and a transport interconnect 160. Each initiator 110 is coupled to the transport interconnect 160 via a corresponding initiator NIU 140. Each target 120 is coupled to the transport interconnect 160 via a corresponding target NIU 150.

Each initiator NIU 140 is configured to convert the protocol used by its corresponding initiator 110 into a transport protocol that is used inside the NoC 130. Each target NIU 150 is configured to convert the protocol used inside the NoC 130 into a transport protocol that is used by its corresponding target 120. The transport protocol is typically based on the transmission of packets.

The transport interconnect 160 transports packets between the initiator NIUs 140 and the target NIUs 150. The transport interconnect 160 includes switches, adapters, and buffers. Switches may be used to route flows of traffic between sources and destinations. Adapters may be used to deal with various conversions between data width, clock domains, and power domains. Buffers may be used to insert pipelining elements to span long distances, or to store packets to deal with rate adaptation between fast senders and slow receivers or vice-versa.

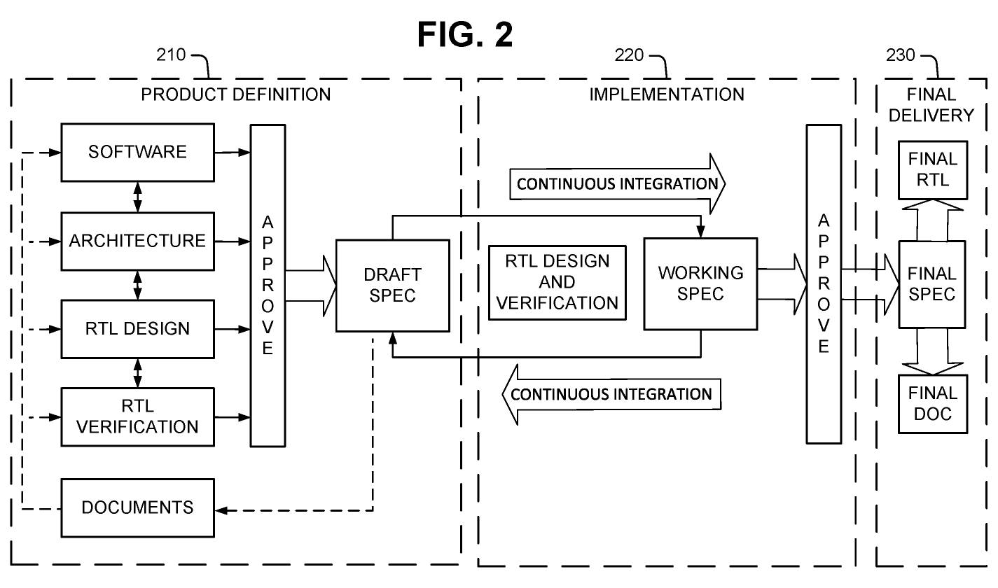

FIG. 2 shows an example of a method of generating a hardware description of a NoC. At block 210, a design tool or product is defined. An SoC architect designs a specification that includes a floorplan for the SoC, power strategy, and constraints related to the environment (e.g., clocks and their frequencies, quality of service, and type of protocol used with macros).

Among other things, the floorplan defines areas on the chip for major functional blocks of the chip, including initiators and targets. The floorplan also defines the area (that is, the “free space”) for the NoC. The SoC architect may place additional constraints on the NoC. Examples of additional constraints include frequency, routing congestion, and power consumption.

The specification also includes a communication policy. The communication policy may specify NoC connectivity for different traffic classes. The communication policy may also require arbitration fairness for certain traffic classes. The communication policy identifies those traffic classes that require arbitration fairness.

A NoC design is generated to fit within the free space defined by the floorplan. Generating the NoC design involves placing and legalizing standard NoC elements, and making wire connections between the NoC elements. A NoC design tool is used to generate the NoC design. The NoC design tool is also used to ensure arbitration fairness as required by the communication policy.

A hardware description of the NoC design is generated. Register Transfer Level (RTL) may be used for design and verification flow. In addition, software is developed. An RTL description may then be delivered to an SoC integrator in the form of a draft specification.

At block 220, the product definition is implemented. The SoC integrator performs integration, synthesis, and simulations to determine whether the NoC design of the RTL description fits into the free space defined by the floorplan, exhibits predictable results about operation frequency, and satisfies other constraints such as routing congestion, and power consumption. The integration is continuous until a working specification has been approved.

At block 230, a final specification is delivered. The final specification may include a final RTL description and documentation.

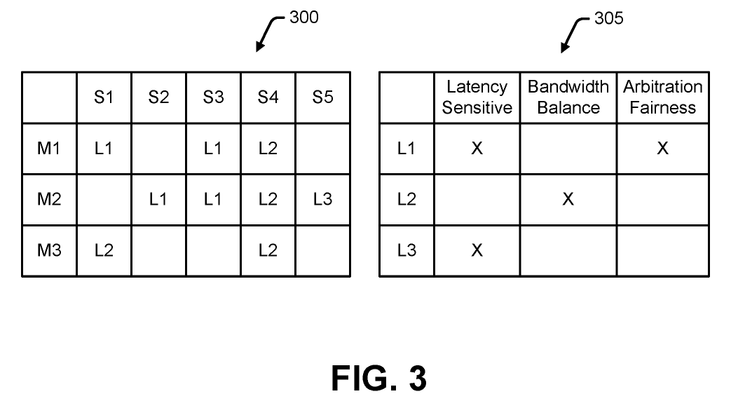

FIG. 3 shows an example connectivity table 300 that specifies NoC connectivity. The connectivity table 300 allows for traffic to be defined by classes. In the example of FIG. 3, there are three traffic classes labeled as L1, L2, and L3.

In the connectivity table 300, each initiator M1, M2 and M3 is assigned a row, and each target S1, S2, S3, S4 and S5 is assigned a column. If a given initiator is specified to send traffic to a given target, a traffic class label is presented at the intersection of the given initiator row and the given target column. If no label is present at the intersection, then there is no connectivity between that given initiator and that given target. For example, initiator M1 is connectively communicating with target S1 per traffic class L1. However, initiator M1 does not communicate with target S2, and hence there is no label at the intersection of initiator M1 and target S2.

A traffic class corresponds to a group of connections that do not necessarily correspond to the whole NoC topology. Different traffic classes may have different properties. For instance, the table 305 of FIG. 3 identifies different properties for the different traffic classes L1, L2 and L3, including latency sensitivity and bandwidth balance.

Table 305 also indicates that arbitration fairness is required for traffic class L1, but not for traffic classes L2 and L3. When a NoC topology is synthesized, switches will connect initiator M1 to targets S1 and S3, and the switches will also connect initiator M2 to targets S2 and S3. The initiators M1 and M2 will have fair or balanced access time.

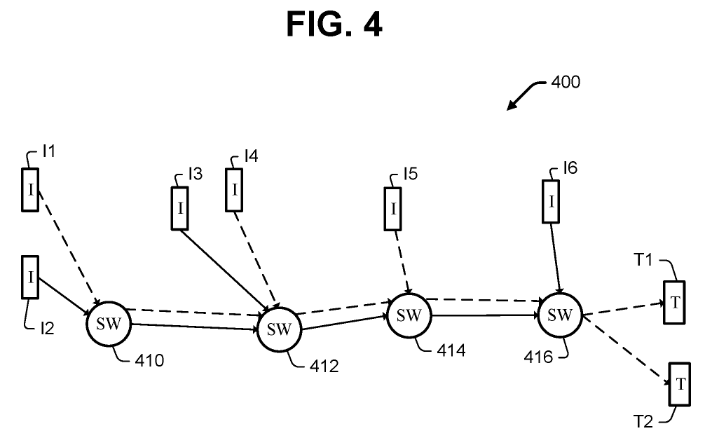

FIG. 4 shows a NoC topology 400 including first, second, third and fourth switches 410, 412, 414 and 416 that are cascaded. These switches 410 to 416 enable initiators I2, I3 and I6 to send traffic to targets T1 and T2 per a first traffic class (as represented by solid lines). These switches 410 to 416 also enable initiators I1, I4 and I5 to send traffic to the first and second targets T1 and T2 per a second traffic class (represented by dash lines).

FIG. 4 shows separate wire connections for the different classes. In practice, however, the different classes may share the same wire connections.

The first traffic class requires arbitration fairness. The second traffic class does not require arbitration fairness.

The fourth switch 416 is closest to the targets T1 and T2. The fourth switch 416 has two input ports, two output ports, and an arbiter for deciding which input port is routed to which output port. When the fourth switch 416 attempts to access one of the targets T1 or T2, it will have to make a choice because initiator I6 (closest to the targets T1 and T2) and the other initiators I2 and I3 cannot access target T1 at the same time. An arbiter that performs round-robin arbitration will give initiator I6 access to target T1 for one cycle and give access to the other port (either initiator I2 or I3) for the other cycle.

Thus, half the access time will be allocated to the closest initiator (initiator I6), and the other half will be allocated to the other initiators (I2 and I3). As a result of this imbalance, access is not fair to initiators I2 and I3 in violation of the communication policy.

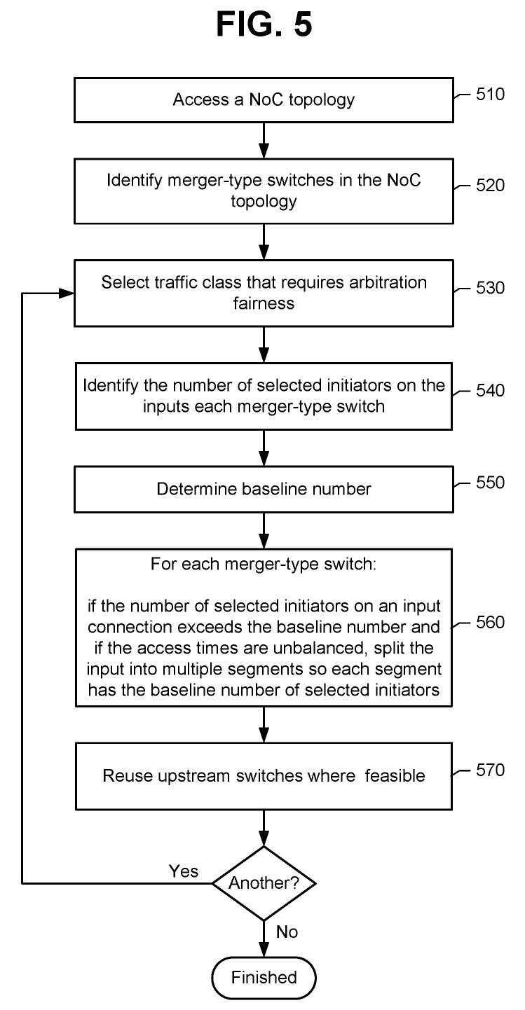

FIG. 5 shows a method of modifying a NoC design to have fair arbitration. At block 510, a network-on-chip (NoC) topology is accessed. In some instances, the accessing includes loading an existing NoC design that includes a NoC topology in an electronic design tool . In other instances, the accessing includes synthesizing an initial NoC topology. The initial NoC topology can be generated automatically by an algorithm, or it may be generated manually by a NoC designer.

At block 520, merger-type switches in the NoC topology are identified. As used herein, a merger-type switch has a plurality of inputs and an arbiter. A merger-type switch may have one or more outputs.

At block 530, a communication policy is accessed, and traffic class that requires arbitration fairness is selected. For example, a connectivity table from an SoC specification is accessed to identify which traffic classes require arbitration fairness, and which traffic classes do not require arbitration fairness.

At block 540, the number of “selected” initiators on the inputs of each merger-type switch is identified. A selected initiator refers to an initiator belonging to the traffic class that is selected. Any initiators not belonging the selected traffic class are not included in the number.

At block 550, a baseline number of selected initiators per input connection is established. The baseline number may be the greatest common denominator (GCD). As a first example, there are three selected initiators on the inputs of a first switch, three selected initiators on the inputs of a second switch, and six initiators on the inputs of a third switch. The GCD and, therefore, the baseline number is three. As a second example, there are three selected initiators on the inputs of a first switch, two selected initiators on the inputs of a second switch, and one selected initiator on the input of a third switch. The GCD is one and, therefore, the baseline number is one.

At block 560, the following is performed for each merger-type switch. If the number of selected initiators on an input exceeds the baseline number of initiators, and if access times on that input are unbalanced, that input is split into a plurality of segments so that each of the segments carries the baseline number of initiators. Each segment then becomes an input to the merger-type switch. For example, an input to a merger-type switch is split into three segments, and each segment carries a selected initiator. The merger-type switch will provide equal access time to the initiators carried on the segments.

The splitting may be performed by inserting a splitter upstream of the merger-type switch. Outputs of the splitter (that is, the segments) are coupled to input ports of the merger-type switch. The splitter may be located proximate the merger-type switch, which is downstream of the splitter, to minimize wire length of the outputs.

If the NoC topology is physically aware, then distances in the NoC topology are known. Advantageously, the distances may be used to locate the splitter as close as feasible to the merger-type switch.

At block 570, switches are reused where feasible. If a merger-type switch immediately upstream of the splitter (the “upstream switch”) has balanced access times, and if the splitting is proximate to the upstream switch, the inputs of the upstream switch may be re-routed to the merger-type switch, and the upstream switch and the splitter are deleted from the NoC topology. Position of the merger-type switch may then be moved (by a place and route algorithm) to minimize wire connection length. By reusing the merger-type switch in this manner, a simpler topology results.

If another traffic class requires arbitration fairness, control is returned to block 530. Otherwise, the method is completed.

The method of FIG. 5 ensures arbitration fairness without changing traffic class separation of the NoC topology. Moreover, the method of FIG. 5 ensures arbitration fairness without changing deadlock freedom. A potential deadlock may be formed by a path leaving an egress port of a NoC element and ultimately returning back to an ingress port of the NoC element. The modifications of FIG. 5 do not create a cyclic dependency, thereby ensuring deadlock freedom.

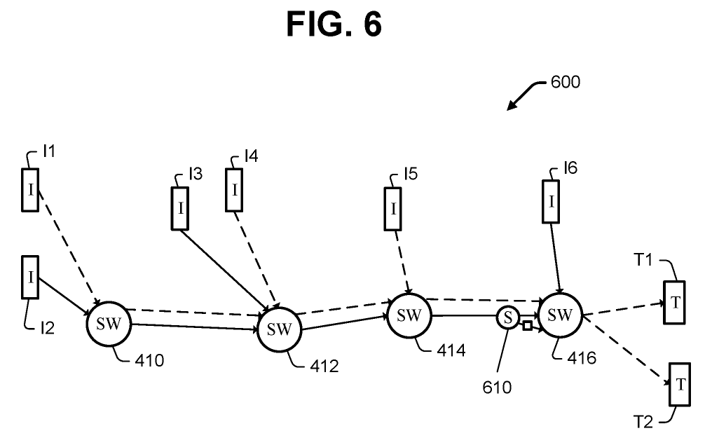

The method of FIG. 5 may be applied to the NoC topology 400 of FIG. 4 to produce the NoC topology 600 of FIG. 6. Each switch 410, 412, 414 and 416 is identified as a merger-type switch. The first traffic class is selected, as it requires arbitration fairness.

The first switch 410 has one selected initiator on its inputs (I2), the second switch 412 has two selected initiators (I2 and I3) on its inputs, the third switch 414 has two selected initiators (I2and I3) on its inputs, and the fourth switch 416 has three selected initiators (I2, I3 and I6) on its inputs. The GCD is one, so the baseline number is one.

The number of selected initiators on the input of the first switch 410 equals the baseline number. The number of selected initiators on each input of the second switch 412 (one per input) also equals the baseline number. Therefore, no modifications are made to the first and second switches 410 and 412.

The number of selected initiators on the input of the third switch 414 equals two, which exceeds the baseline number. However, the access time is balanced, since each initiator I2 and I3 still has an equal amount of access time (per the arbiter of the second switch 412), and the initiators I2 and I3 do not have to share access time with any other selected initiators. Therefore, no modifications are made to the third switch 414.

The fourth switch 416 has a first input that carries initiators I2 and I3, and a second input that carries initiator I6. Without modifying the fourth switch, initiator I6 would have greater access time to the targets T1 and T2 than either initiator I2 or I3. To ensure arbitration fairness, a splitter 610 is inserted upstream of the fourth switch 416 to split the first input into two segments, such that one of the segments carries initiator I2 and the other of the segments carries initiator I3. Thus, the arbiter of the fourth switch 416 provides equal access to all three initiators I2, I3 and I6.

The second traffic class does not require fairness arbitration. Therefore, the method is completed.

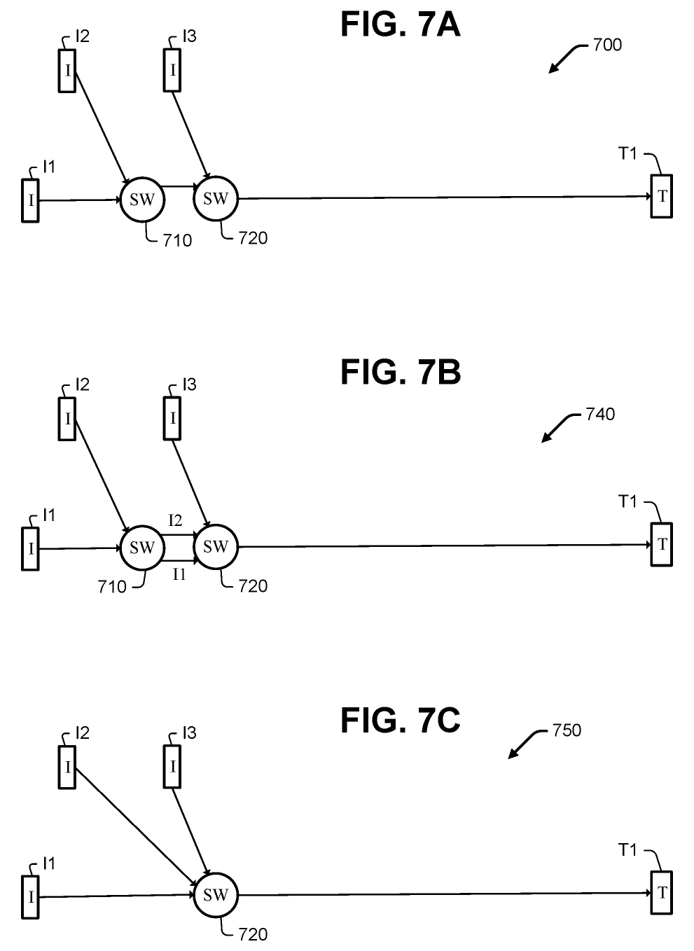

FIGS. 7A, 7B and 7C illustrate switch re-use. FIG. 7A shows an initial NoC topology 700 in which a first switch 710 has an input that carries a first initiator I1 and another input that carries a second initiator I2. The first switch 710 is cascaded with a second switch 720. One input to the second switch 710 carries the first and second initiators I1 and I2. Another input to the second switch 720 carries a third initiator I3. Thus, the third initiator I3 will have greater access time to target T1 than either the first initiator I1 or the second initiator I2.

Blocks 540-560 of FIG. 5 are applied to the NoC topology 700 of FIG. 7A to produce the NoC topology 740 of FIG. 7B. The input that carries the first and second initiators I1 and I2 to the second switch 720 is split into two segments (a splitter is now shown). Now, each segment carries a single initiator, whereby the first, second and third initiators I1, I2 and I3 will have equal access to the target T1.

Block 570 of FIG. 5 is applied to the NoC topology 740 of FIG. 7B to produce the NoC topology 750 of FIG. 7C. The first switch 710, which is immediately upstream of the splitter has balanced access times. Since the splitting is proximate to the first switch 710, the inputs of the first switch 710 are re-routed to the second switch 720 and the first switch 710 and the splitter are deleted or removed or eliminated from the NoC topology 750. The initiators I1, I2 and I3 still have equal access to the target T1. However, the NoC topology 750 of FIG. 7C is simpler than the NoC topology 740 of FIG. 7B.

In the examples above, the method of FIG. 5 is applied to cascaded switches and an arbiter that is configured to perform round-robin type arbitration. However, a method herein is not limited to any particular topology shape.

In the examples above, traffic classes are used to select the initiators which, in turn identify the merger-type switches to modify. In other embodiments, merger-type switches may be identified by other means.

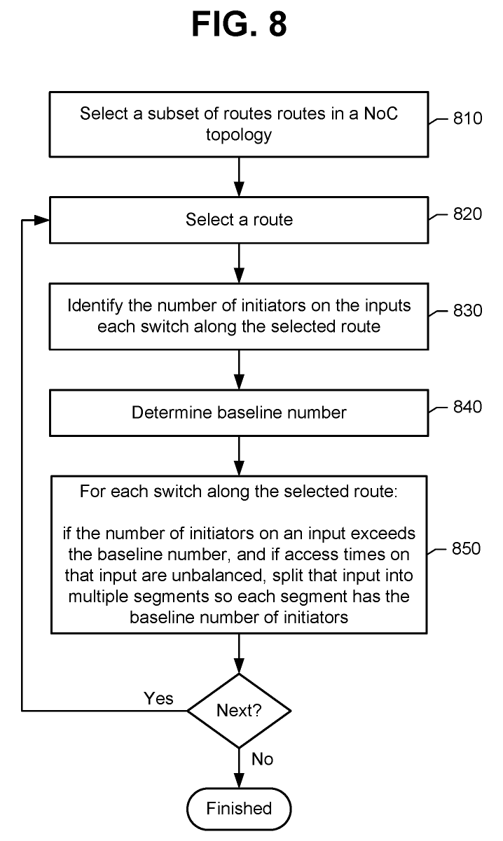

Reference is made to FIG. 8, which shows another method of ensuring arbitration fairness on a NoC topology. At block 810, a subset of routes in the NoC topology is selected. The subset may be user-defined (traffic classes being one way to identify a group of routes), or may be inferred following running a simulation on a Noc topology or running a traffic simulation wherein fairness issues were detected.

At block 820, a route is selected. At block 830, the number of initiators on the inputs of each switch along the selected route are identified. At block 840, a baseline number of initiators is determined. At block 850, for each switch along the selected route, if the number of initiators on an input exceeds the baseline number, and if access times on that input are unbalanced, then that input is split into multiple segments so that each segment carries the baseline number of initiators.

Control is returned to block 820 to select the next route. When all routes in the subset have been processed, the method is completed.

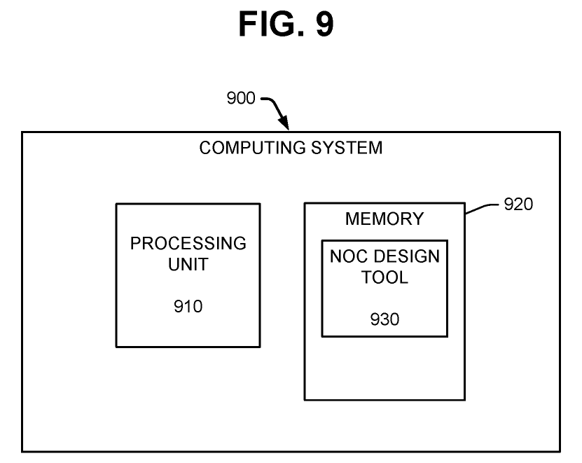

Reference is now made to FIG. 9, which illustrates a computing system 900 including a processing unit 910, and computer-readable memory 920 that stores a NoC design tool 930. The NoC design tool 930 can access a NoC topology, for example, by using an algorithm to synthesize an initial NoC topology or by loading an existing NoC design from the computer-readable memory 920 or from a remote source. In some embodiments, the NoC design tool 930 includes an algorithm that, when executed,

ensures arbitration fairness in the accessed NoC topology according to a method herein. In other embodiments, the memory 920 stores a standalone application that can be invoked by the NoC design tool to ensure arbitration fairness according to a method herein.

Certain methods, which can be implemented in a product, according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code comprising instructions according to various example.

Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Various examples are methods that use the behavior of either or a combination of machines. Method examples are complete wherever in the world most constituent steps occur. For example, IP elements or units include: processors (e.g., CPUs or GPUs), random-access memory (RAM – e.g., off-chip dynamic RAM or DRAM), a network interface for wired or wireless connections such as ethernet, WiFi, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms "including", "includes”, “having", "has", "with", or variants thereof are used in either the detailed description and the claims, such terms are intended to be inclusive in a similar manner to the term "comprising."

The scope of the invention, therefore, is not intended to be limited to the exemplary embodiments shown and described herein. Rather, the scope and spirit of present invention is embodied by the appended claims.

What is claimed is:

1. A computer-implemented method, comprising:
accessing a network-on-chip (NoC) design in which a plurality of switches connect initiators to targets, wherein the plurality of switches includes at least one merger-type switch having an arbiter and a plurality of inputs;
identifying, for each merger-type switch, a number of initiators on the plurality of inputs;
determining a baseline number of initiators per input connection; and
for each merger-type switch if the number of initiators on an input exceeds the baseline number of initiators, and if access times on that input are unbalanced, that input is split into a plurality of segments so that each of the segments carries the baseline number of initiators;
whereby arbitration fairness is ensured without changing deadlock freedom of the NoC design.

2. The method of claim 1, wherein traffic in the NoC design has traffic classes; and wherein the identifying of the number of initiators, the determining of the baseline number, and the splitting are performed for each traffic class that requires arbitration fairness; and wherein the initiators belonging to the traffic class being processed are used in the identifying, the determining, and the splitting.

3. The method of claim 2, further comprising accessing a connectivity table that specifies NoC connectivity for different traffic classes, wherein the connectivity table further identifies those traffic classes that require arbitration fairness.

4. The method of claim 1, further comprising identifying a subset of routes in the NoC design; selecting a route; and identifying merger-type switches along the route that is selected; wherein identifying the number of initiators, determining the baseline number, and splitting the input are performed on the merger-types switches along the route that is selected.

5. The method of claim 4, wherein the subset is selected by steps including:
running a simulation on a NoC topology;
detecting fairness issues in the simulation; and
inferring the subset the fairness issues that were detected.

6. The method of claim 1, wherein the arbiter of each merger-type switch is configured to perform round-robin arbitration.

7. The method of claim 1, wherein the accessing includes generating an initial NoC topology with the merger-type switches.

8. The method of claim 1, further comprising inserting a splitter in the input to split the input into a plurality of segments, wherein distances in the NoC design are known and wherein the distances are used to locate the splitter as close as feasible to the merger-type switch immediately downstream of the splitter resulting in a downstream switch.

9. The method of claim 8, wherein if a merger-type switch immediately upstream of the splitter (“upstream switch”) has inputs with balanced access times, the inputs of the upstream switch are re-routed to the downstream switch, and the upstream switch and the splitter are eliminated from a NoC topology.

10. The method of claim 1, wherein the plurality of switches in the NoC design includes merger-type switches that are cascaded.

11. A design tool comprising non-transitory computer readable medium for storing code that, when executed by a processing unit, causes the design tool to:
access a network-on-chip (NoC) design in which a plurality of switches connect initiators to targets, wherein the plurality of switches includes at least one merger-type switch having an arbiter and a plurality of inputs;
identify, in each merger-type switch, number of initiators on the plurality of inputs;
determine a baseline number of initiators per input connection; and
for each merger-type switch:
if the number of initiators on an input exceeds the baseline number of initiators, and if access times on that input are unbalanced, split that input into a plurality of segments so that each of the segments carries the baseline number of initiators.

12. The design tool of claim 11, wherein traffic in the NoC design is separated by traffic classes; wherein the number of initiators is identified, the baseline number is determined, and the splitting is performed for each traffic class that requires arbitration fairness; and wherein only the initiators belonging to the traffic class being processed are used to identify the number of initiators, determine the baseline number, and perform the splitting.

13. The design tool of claim 12, wherein the code, when executed, further causes the NoC design tool to access a connectivity table that specifies NoC connectivity for different traffic classes; and wherein the connectivity table further identifies those traffic classes that require arbitration fairness.

14. The design tool of claim 11, wherein the splitting is performed by inserting a splitter; wherein distances in the NoC design are known; and wherein the distances are used to locate the splitter as close as feasible to the merger-type switch immediately downstream of the splitter (“downstream switch”).

15. The design tool of claim 14, wherein if a merger-type switch immediately upstream of the splitter (“upstream switch”) has inputs with balanced access times, the code, when executed, further causes the NoC design tool to re-route inputs of the upstream switch to the downstream switch, and delete the upstream switch and the splitter from a NoC topology.

16. A network-on-chip (NoC) design tool comprising a processing unit and computer-readable memory including code, which when executed causes the design tool to:
access a network-on-chip (NoC) design in which a plurality of merger-type switches connect initiators to targets, wherein each of a plurality of merger type switches has an arbiter and a plurality of inputs;
identify in each merger-type switch a number of initiators on the plurality of inputs;
determine a baseline number of initiators per input connection; and
for each merger-type switch, if the number of initiators on an input exceeds the baseline number of initiators, and if access times on that input are unbalanced, split that input into a plurality of segments so that each of the segments carries the baseline number of initiators.

17. The design tool of claim 16, wherein traffic in the NoC design is separated by traffic classes; wherein the number of initiators is identified, the baseline number is determined, and the splitting is performed for each traffic class that requires arbitration fairness; and wherein only the initiators belonging to the traffic class being processed are used to identify the number of initiators, determine the baseline number, and perform the splitting.

18. The design tool of claim 17, wherein the code, when executed, further causes the processing unit to access a connectivity table that specifies NoC connectivity for different traffic classes; and wherein the connectivity table further identifies those traffic classes that require arbitration fairness.

19. The design tool of claim 16, wherein the splitting is performed by inserting a splitter; wherein distances in the NoC design are known; and wherein the distances are used to locate the splitter as close as feasible to the merger-type switch immediately downstream of the splitter (“downstream switch”).

20. The design tool of claim 19, wherein if a merger-type switch immediately upstream of the splitter (“upstream switch”) has inputs with balanced access times, the code, when executed, further causes the processing unit to re-route inputs of the upstream switch to the downstream switch, and delete the upstream switch and the splitter from a NoC topology.
